(19) United States
(12) Patent Application Publication
(10) Pub. No.: US 2026/0052382 A1
(43) Pub. Date: Feb. 19, 2026

(54) METHOD AND DEVICE FOR TRANSMITTING INFORMATION, AND COMMUNICATION DEVICE AND STORAGE MEDIUM

(71) Applicant: Beijing Xiaomi Mobile Software Co., Ltd., Beijing (CN)

(72) Inventor: Wei LU, Beijing (CN)

(73) Assignee: Beijing Xiaomi Mobile Software Co., Ltd., Beijing (CN)

(21) Appl. No.: 19/103,135

(22) PCT Filed: Aug. 12, 2022
(86) PCT No.: PCT/CN2022/112127

§ 371 Date: Feb. 11, 2025

(51) Int. Cl. H04W 12/0431; H04W 40/24; H04W 88/04

(52) U.S. Cl. CPC H04W 12/0431; H04W 40/246; H04W 88/04

(57) ABSTRACT

A method for transmitting information is provided. The method for transmitting information includes: a discovery security management function receiving a relay discovery key request transmitted by user equipment (UE) via a base station, where the relay discovery key request is used to request a relay discovery security parameter corresponding to relay discovery; and determining, based on the relay discovery key request, whether the UE uses a security method assigned to the UE.

### CROSS-REFERENCE TO RELATED APPLICATIONS

The present application is a U.S. National Stage of International Application No. PCT/CN2022/112127, filed on Aug. 12, 2022, the contents of all of which are incorporated herein by reference in their entireties for all purposes.

### BACKGROUND OF THE INVENTION

A security method based on a control plane (CP) and a security method based on a user plane (UP) are available for security protection of proximity-based services (ProSe) in a 5-th generation cellular mobile communication system, and serve to provide security guarantee for proximity communication (PC5) between remote user equipment (UE) and a user to network relay (U2N relay). The remote UE and the U2N relay need to discover each other before the security methods are used. The security method based on the CP and the security method based on the UP are also available for U2N relay discovery before relay communication.

### SUMMARY OF THE INVENTION

Examples of the present disclosure disclose a method and device for transmitting information, a communication device and a storage medium.

A method for transmitting information is provided. The method is performed by a discovery security management function and includes: receiving a relay discovery key request transmitted by user equipment (UE) via a base station, where the relay discovery key request is used to request a relay discovery security parameter corresponding to relay discovery; and determining, based on the relay discovery key request, whether the UE uses a security method assigned to the UE.

A method for transmitting information is provided. The method is performed by UE and includes: transmitting a relay discovery key request to a discovery security management function via a base station, where the relay discovery key request is used to request a relay discovery security parameter corresponding to relay discovery, and the relay discovery key request is at least used for the discovery security management function to determine whether the UE uses a security method assigned to the UE.

A method for transmitting information is provided. The method is performed by a PCF and includes:
receiving an RSC of relay discovery transmitted by a discovery security management function, where the RSC is used for the PCF to determine a security method assigned to UE, the RSC is carried by the UE in a relay discovery key request and transmitted to the discovery security management function, and the relay discovery key request is at least used to request a relay discovery security parameter corresponding to the relay discovery.

A communication device is provided. The communication device includes:
one or more processors; and
a memory that stores processor-executable instructions, where
the one or more processors are collectively configured to implement the method for transmitting information when running the executable instructions.

A non-transitory computer-readable storage medium is provided. The non-transitory computer-readable storage medium stores a computer-executable program, and the computer-executable program, when performed by one or more processors, implements the method for transmitting information.

It should be understood that the above general description and the following detailed description are only illustrative and explanatory, and cannot limit the examples of the present disclosure.

### BRIEF DESCRIPTION OF DRAWINGS

FIG. 1 is a schematic structural diagram of a wireless communication system.

FIG. 2 is a flowchart of a method for transmitting information according to an example.

FIG. 3 is a flowchart of a method for transmitting information according to an example.

FIG. 4 is a flowchart of a method for transmitting information according to an example.

FIG. 5 is a flowchart of a method for transmitting information according to an example.

FIG. 6 is a flowchart of a method for transmitting information according to an example.

FIG. 7 is a flowchart of a method for transmitting information according to an example.

FIG. 8 is a flowchart of a method for transmitting information according to an example.

FIG. 9 is a flowchart of a method for transmitting information according to an example.

FIG. 10 is a flowchart of a method for transmitting information according to an example.

FIG. 11 is a block diagram of a device for transmitting information according to an example.

FIG. 12 is a block diagram of a device for transmitting information according to an example.

FIG. 13 is a block diagram of a device for transmitting information according to an example.

FIG. 14 is a mechanism block diagram of a communication system according to an example.

FIG. 15 is a block diagram of user equipment (UE) according to an example.

FIG. 16 is a block diagram of a base station according to an example.

### DETAILED DESCRIPTION OF THE INVENTION

The examples will be described in detail here and illustratively shown in the accompanying drawings. When the following descriptions relate to the accompanying drawings, unless otherwise specified, the same numerals in different accompanying drawings denote the same or similar elements. The implementations described in the following examples do not denote all implementations consistent with the examples of the present disclosure. On the contrary, the implementations are merely examples of a device and a method consistent with some aspects of the examples of the present disclosure as detailed in the appended claims.

The terms used in the examples of the present disclosure are merely to describe the specific examples, instead of limiting the examples of the present disclosure. The singular forms such as “a”, “an”, “the” and “this” used in the examples of the present disclosure and the appended claims are also intended to include the plural forms, unless otherwise clearly stated in the context. It should be further understood that the term “and/or” used here refers to and includes any of one or more of the associated listed items or all possible combinations.

It should be understood that although the terms of first, second, third, etc. can be used in the examples of the present disclosure to describe any type of information, such information should not be limited to these terms. These terms are merely configured to distinguish the same type of information from each other. For example, without departing from the scope of the examples of the present disclosure, first information may alternatively be referred to as second information, and similarly, second information may alternatively be referred to as first information. Depending on the context, the word “if” as used here can be interpreted as “at the time of” or “when” or “in response to determining”.

The present disclosure relates to, but not limited to, the technical field of communication, and in particular to a method and device for transmitting information, a communication device and a storage medium.

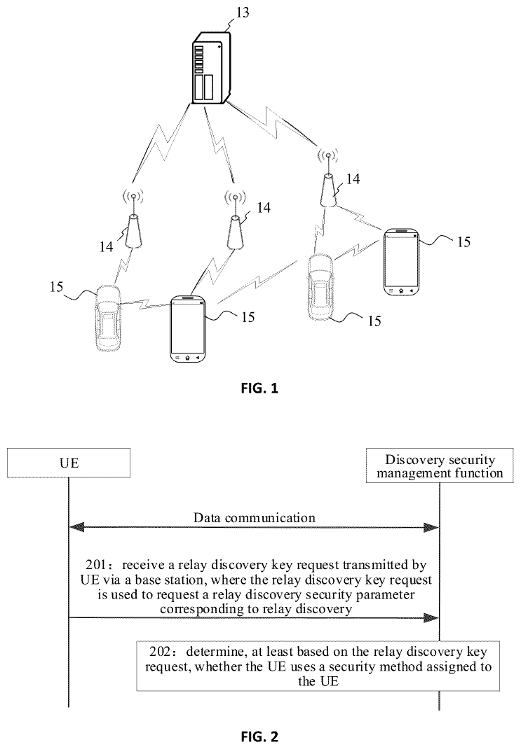

With reference to FIG. 1, a schematic structural diagram of a wireless communication system according to an example of the present disclosure is shown. As shown in FIG. 1, the wireless communication system is a communication system based on a cellular mobile communication technology, and may include several pieces of user equipment (UE) 15 and several base stations 14.

The UE 15 may be a device that provides voice and/or data connectivity for a user. The UE 15 may communicate with one or more core networks via a radio access network (RAN). The UE 15 may be the Internet of Things UE, such as a sensor device, a mobile phone (also known as a “cellular” phone) and a computer having Internet of Things UE. For example, the UE may be a fixed, portable, pocket, hand-held, computer built-in, or vehicle-mounted device. For example, the UE may be a station (STA), a subscriber unit, a subscriber station, a mobile station, a mobile, a remote station, an access point, a remote terminal, an access terminal, a user terminal, a user agent, a user device, or UE. Alternatively, the UE 15 may be a device of an unmanned aerial vehicle. Alternatively, the UE 15 may be a vehicle-mounted device, for example, an electronic control unit having a wireless communication function, or a wireless UE externally connected to the electronic control unit. Alternatively, the UE 15 may be a roadside device, for example, a street lamp, a signal lamp or another roadside device having a wireless communication function.

The base station 14 may be a network-side device in the wireless communication system. The wireless communication system may be a fourth generation mobile communication (4G) system, and is also known as a long term evolution (LTE) system. Alternatively, the wireless communication system may be a fifth generation mobile communication (5G) system, and is also known as a new radio (NR) system or a 5G NR system. Alternatively, the wireless communication system may be a next-generation system after a 5G system. An access network in the 5G system may be known as a new generation-radio access network (NG-RAN).

The base station 14 may be an evolved node B (eNB) used in the 4G system. Alternatively, the base station 14 may be a generalized node B (gNB) using centralized distributed architectures in the 5G system. When the base stations 14 use the centralized distributed architectures, the base stations each usually includes a central unit (CU) and at least two distributed units (DUs). Protocol stacks of a packet data convergence protocol (PDCP) layer, a radio link control (RLC) layer, and a media access control (MAC) layer are arranged in the CU; and protocol stacks of physical (PHY) layers are arranged in the DUs. The specific implementation of the base stations 14 is not limited in the example of the present disclosure.

Wireless connections may be established between the base stations 14 and the UE 15 by wireless air interfaces. In different implementations, the wireless air interface is a radio air interface based on a 4G standard; alternatively, the wireless air interface is a wireless air interface based on a 5G standard, for example, a NR; and alternatively, the wireless air interface may be a wireless air interface based on a next-generation mobile communication network technology standard after 5G.

In some examples, an end to end (E2E) connection may be further established between UE 15, for example, vehicle to vehicle (V2V) communication, vehicle to infrastructure (V2I) communication and vehicle to pedestrian (V2P) communication in vehicle to everything (V2X) communication.

The above UE may be considered as a terminal device in the following example here.

In some examples, the above wireless communication system may further include a network management device 13.

The several base stations 14 are each connected to the network management device 13. The network management device 13 may be a core network device in the wireless communication system. For example, the network management device 13 may be a mobility management entity (MME) in an evolved packet core (EPC). Alternatively, the network management device may be another core network device, such as a serving gateway (SGW), a public data network gateway (PGW), a policy and charging rules function (PCRF), or a home subscriber server (HSS). The implementation form of the network management device 13 is not limited in the example of the present disclosure.

In order to facilitate understanding by those skilled in the art, a plurality of implementations are listed in the example of the present disclosure to clearly describe the technical solution of the example of the present disclosure. Certainly, those skilled in the art can understand that the plurality of examples according to the example of the present disclosure can be executed separately, may be executed jointly in combination with the methods of other examples in the example of the present disclosure, or may be further executed together with some methods of other related art separately or in combination, which are not limited in the example of the present disclosure.

5G ProSe UE-to-network (U2N) relay discovery parameters may include a control panel (CP) security indicator. The control plane security indicator is provided by a policy control function (PCF) to remote user equipment (UE) and relay UE separately. If the control plane security indicator is provided for a particular relay service code (RSC), it indicates that a security method is performed on a control plane. If no control plane security indicator is provided, the security method is performed on a user plane. A U2N relay may be configured to use a set of slices that support the security method based on the control plane. When a requested slice corresponding to the security method based on the control plane is accepted, the U2N relay shall include an RSC having the control plane security indicator in a discovery message.

However, the security method assigned may not be used by all UE according to a rule. For example, if the control plane security indicator is provided by the RSC assigned to the UE (which includes the remote UE and/or the relay UE), the security method based on the user plane may be still used by the UE.

Thus, for protecting a 5G ProSe discovery process, how to verify that the security method assigned is used by the UE is a problem urgently to be solved.

As shown in FIG. 2, a method for transmitting information is provided in an example of the present disclosure. The method is performed by a discovery security management function and includes steps 201-202.

Step 201: a relay discovery key request transmitted by UE via a base station is received, where the relay discovery key request is used to request a relay discovery security parameter corresponding to relay discovery.

Step 202: whether a security method assigned to the UE is used by the UE is determined at least based on the relay discovery key request.

A 5G mobile communication system will be described as an example in the example, but the method of the example may not be limited to be applied to the 5G mobile communication system, for example, may be applied to a next-generation mobile communication system, which is not limited here.

The method of the example may be applied to a model A and a model B of 5G ProSe user to network (U2N) discovery.

Here, the security method includes a security method based on a control plane and a security method based on a user plane used in a 5G ProSe discovery process.

The discovery security management function may be a core network element for security management in a ProSe.

The relay discovery security parameter may include at least one of the following associated with the relay discovery: a discovery key; algorithms for encryption and integrity protection of a discovery message; a timing parameter associated with a timer; etc.

In a possible implementation, a discovery security management function may be used to provide a security key, a security algorithm, etc. to relay UE and/or remote UE.

In a possible implementation, different types of discovery security management functions are associated with different security methods. Illustratively, one type of discovery security management function uses a security method based on a control plane, and another type of discovery security management function uses a security method based on a user plane.

In an example, the discovery security management function includes one of the following:
a ProSe key management function (PKMF); and
a direct discovery name management function (DDNMF).

In a possible implementation, a security method based on a user plane is used by a PKMF.

In a possible implementation, a security method based on a control plane is used by a DDNMF.

The UE may be remote UE in a 5G ProSe, or relay UE in a 5G ProSe. The relay UE may be a U2N relay in the 5G ProSe.

In an example, the security method assigned to the UE is determined and indicated to the UE by the PCF of the UE.

The security method assigned to the UE may be determined by the PCF of the UE and indicated to the UE by the PCF of the UE.

In a possible implementation, a security method needing to be assigned to the UE is indicated to the UE by a PCF during registration of UE to a network.

In a possible implementation, an address of a discovery security management function of the UE and a discovery parameter are acquired from a PCF by UE during service authorization and information provision. The discovery parameter may include at least one of the following: an RSC; and a control plane security indicator. When the discovery parameter includes the control plane security indicator, it indicates that the UE is instructed by the PCF to use the security method based on the control plane. When the discovery parameter does not include the control plane security indicator, it indicates that the UE is instructed by the PCF to use the security method based on the user plane. The control plane security indicator is associated with the RSC.

The UE may select the discovery security management function after determining the security method assigned to the UE, and transmit a relay discovery key request to the discovery security management function. However, since the security method may be performed by not all UE according to the rule. For example, the control plane security indicator is provided by the RSC assigned to the UE. That is, the security method based on the control plane needs to be performed by the UE. But the security method based on the user plane may be still used by the UE. That is, the relay discovery key request is transmitted to the PKMF (which uses the security method based on the user plane) by the UE. Alternatively, the control plane security indicator is not provided by the RSC assigned to the UE. That is, the security method based on the user plane needs to be performed by the UE. But the security method based on the control plane may be still used by the UE. That is, the relay discovery key request is transmitted to the DDNMF (which uses the security method based on the control plane) by the UE. Thus, the security method of a relay service may not be executed correctly, thus affecting security of the relay service.

Here, the security method assigned to the UE based on the relay discovery key request may be determined by the security management function.

In a possible implementation, indication information for determining a security method assigned to the UE may be carried by a relay discovery key request.

The security method assigned to the UE may be explicitly or implicitly indicated by the indication information for determining the security method assigned to the UE.

In a possible implementation, indication information for determining the security method assigned to the UE may include an RSC assigned to the UE.

If the security method assigned to the UE is used by the UE, the security method supported by the security management function is consistent with the security method assigned to the UE.

If the security method assigned to the UE is not used by the UE, the security method supported by the security management function may not be consistent with the security method assigned to the UE.

The security method supported by the security management function may be compared with the security method assigned to the UE by the security management function, and whether the security method assigned to the UE is used by the UE is further determined by the security management function.

Thus, whether the security method assigned to the UE is used by the UE is determined by the discovery security management function based on the relay discovery key request. Thus, a security risk caused by the discovery security management function failing to support the security method assigned to the UE can be reduced, and relay service security can be improved.

In a possible implementation, the relay discovery key request further includes at least one of the following:
an identifier (ID) of UE; and
security capability information of the UE, such as a security algorithm that may be supported.

Illustratively, a relay discovery key request may be transmitted to a discovery security management function (PKMF or DDNMF) of relay UE by the relay UE, and at least one of the following: an RSC, an ID of the relay UE, and security capability information of the relay UE may be carried by the relay discovery key request.

Illustratively, a relay discovery key request may be transmitted to a discovery security management function (PKMF or DDNMF) of the remote UE by remote UE, and at least one of the following: an RSC, an ID of the remote UE, and security capability information of the remote UE may be carried by the relay discovery key request.

Core network elements of the relay UE and the remote UE may be identical or different. That is, the discovery security management function of the relay UE and the discovery security management function of the remote UE may be the same network element or different network elements. A PCF of the relay UE and a PCF of the remote UE may be the same network element or different network elements.

In an example, the step that whether a security method assigned to the UE is used by the UE is determined at least based on the relay discovery key request includes:
an RSC associated with the relay discovery is transmitted to a PCF of the UE, where the RSC is carried in the relay discovery key request;
indication information indicating the security method assigned to the UE and transmitted by the PCF to the discovery security management function in response to the RSC is received; and
whether the security method assigned to the UE is used by the UE is determined based on a security method associated with the discovery security management function.

In a possible implementation, an RSC of UE is carried in a security method check request and transmitted to a PCF of the UE by a discovery security management function.

In a possible implementation, a mapping table between different UE and PCF addresses is preset in a discovery security management function. For example, the discovery security management function may have a mapping table between IDs of the UE to the PCF addresses. The address of the PCF of the UE is determined by the discovery security management function based on the ID of the UE in the relay discovery key request, and an RSC carried by the UE in a relay discovery key request is further transmitted to the PCF by the discovery security management function.

The RSC for the UE may be configured by the PCF during service authorization and information configuration of the UE. The RSC may have a corresponding control plane security indicator indicating that a security method based on a control plane needs to be performed by the UE to which the RSC is assigned during discovery. If the RSC may not have the corresponding control plane security indicator, a security method based on a user plane needs to be performed by the UE to which the RSC is assigned during discovery.

A corresponding relation between each RSC and the corresponding security method may be saved by the PCF.

In a case where the RSC transmitted by the discovery security management function is received, the security method corresponding to the RSC may be determined by the PCF based on the corresponding relation between the RSC and the corresponding security method. The security method corresponding to the determined RSC is transmitted to the discovery security management function by the PCF by indication information, i.e. the discovery security management function is informed by the PCF of the security method assigned to the UE.

In a possible manner, indication information of a determined security method assigned to the UE is carried in a security method check response and transmitted to a security management function by a PCF.

In a possible manner, a discovery security management function carries an ID of UE in a security method check request when transmitting a security method check request carrying an RSC to a PCF of the UE, so as to indicate the UE corresponding to the security method requested.

In a possible manner, an ID of UE corresponding to a security method is carried by a PCF in a security method check response, so as to inform the UE corresponding to the security method.

A discovery security management function determines whether the discovery security management function supports the security method after receiving the security method assigned to the UE indicated by the PCF. If it is determined that a security method of the security management function is the same as the security method assigned to the UE indicated by the PCF, it may be determined that the security method assigned to the UE is used by the UE. If it is determined that the security method of the security management function is different from the security method assigned to the UE indicated by the PCF, it may be determined that the security method assigned to the UE is not used by the UE.

Thus, the security method assigned to the UE is determined by the PCF. Thus, accuracy of determination of the security method assigned to the UE is improved. Further, whether the security method assigned is used by the UE is determined. Thus, a security risk caused by the discovery security management function failing to support the security method assigned to the UE can be reduced, and relay service security can be improved.

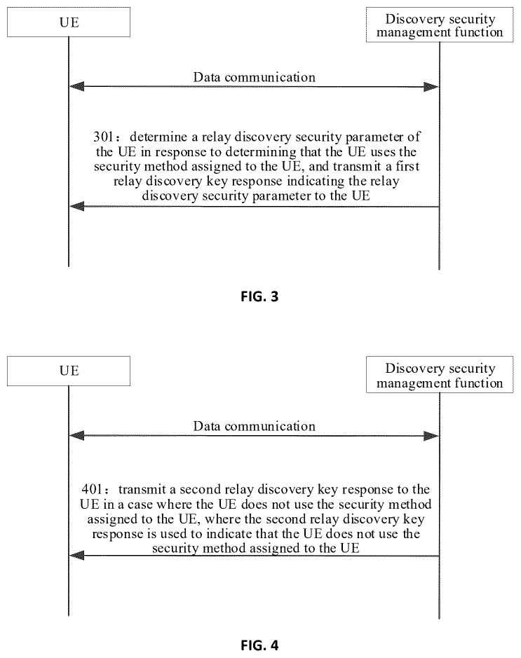

As shown in FIG. 3, a method for transmitting information is provided in an example of the present disclosure. The method is performed by a discovery security management function and includes step 301.

Step 301: a relay discovery security parameter of the UE is determined in response to determining that the security method assigned to the UE is used by the UE, and a first relay discovery key response indicating the relay discovery security parameter is transmitted to the UE.

Step 301 may be implemented separately or jointly in combination with step 201.

The discovery security management function may provide a security service to the UE after determining that the security method assigned to the UE is supported by the security management function, i.e. the security method assigned is used by the UE.

In a possible implementation, if a security method received by a discovery security management function from a PCF matches a role of the discovery security management function (i.e. a security method of the discovery security management function is the same as the security method assigned to UE received from the PCF, i.e. the security method assigned is used by the UE), a relay discovery security parameter of the UE may be determined by the discovery security management function, and the relay discovery security parameter may be transmitted to the UE by the discovery security management function.

In a possible implementation, a relay discovery security parameter includes, but not limited to, at least one of the following: a discovery key; algorithms for encryption and integrity protection of a discovery message; a timing parameter associated with a timer; etc.

In a possible implementation, the step that a relay discovery security parameter of the UE is determined, and a first relay discovery key response indicating the relay discovery security parameter is transmitted to the UE includes:
in a case where the UE is relay UE, the relay discovery security parameter of the relay UE is determined by a key management function, and the first relay discovery key response indicating the relay discovery security parameter is transmitted to the relay UE by the key management function.

Illustratively, if the security method received by the discovery security management function of the relay UE from the PCF matches the role of the discovery security management function of the relay UE (i.e. the relay UE uses the security method assigned), a discovery security material (i.e. relay discovery security parameter) is generated by the discovery security management function (5G PKMF or 5G DDNMF) of the relay UE for the relay UE. The algorithms for encryption and integrity protection of the discovery message broadcast between UE may also be selected by the discovery security management function of the relay UE based on the received security capability information of the relay UE. A first relay discovery key response message carrying the relay discovery security parameter is transmitted to the relay UE by the discovery security management function of the relay UE.

In a possible implementation, the step that a relay discovery security parameter of the UE is determined, and a first relay discovery key response indicating the relay discovery security parameter is transmitted to the UE includes:
in a case where the UE is remote UE, the relay discovery key request is transmitted to a key management function of relay UE;
the relay discovery security parameter transmitted by the key management function of the relay UE in response to the relay discovery key request is received; and
the relay discovery key response indicating the relay discovery security parameter is transmitted to the remote UE.

Illustratively, if the security method received by the discovery security management function of the remote UE from the PCF matches the role of the discovery security management function of the remote UE (i.e. the remote UE uses the security method assigned), a discovery security management function (5G PKMF or 5G DDNMF) of potential relay UE is positioned by the discovery security management function (5G PKMF or 5G DDNMF) of the remote UE according to a received RSC, and then a relay discovery key request message is forwarded to the discovery security management function of the relay UE by the discovery security management function of the remote UE.

A relay discovery key request message is received from the discovery security management function of the remote UE by the discovery security management function of the relay UE, and one piece of the relay UE in a domain of the discovery security management function is authorized by the discovery security management function of the relay UE to provide the relay service based on the received RCS.

Based on the received RSC, the relay discovery security parameter generated for the RSC is retrieved by the discovery security management function of the relay UE, and a response us made to the discovery security management function of the remote UE by the discovery security management function of the relay UE by the relay discovery key response message.

The relay discovery security parameter carried in the relay discovery key response message is forwarded to the remote UE by the discovery security management function of the remote UE.

The remote UE and the relay UE separately perform on a PC5 to discover each other. It should be noted that if either of the remote UE and the relay UE fails to obtain the relay discovery security parameter, the UE may not transmit a protected discovery message or understand/verify a received discovery message, so as to successfully discover each other. That is, only UE that correctly uses a security method assigned to the RSC may discover each other.

As shown in FIG. 4, a method for transmitting information is provided in an example of the present disclosure. The method is performed by a discovery security management function and includes step 401.

Step 401, in a case where UE does not use a security method assigned to the UE, a second relay discovery key response is transmitted to the UE. The second relay discovery key response is used to indicate that the security method assigned to the UE is not used by the UE.

Step 401 may be implemented separately or jointly in combination with step 201 and/or step 301.

If the security method received by a discovery security management function from a PCF does not match a role of the discovery security management function (i.e. a security method of the discovery security management function is different from the security method assigned to the UE received from the PCF, i.e., the security method assigned is not used by the UE), the second relay discovery key response is transmitted to the UE by the discovery security management function, so as to explain the cause of failure in acquiring the relay discovery security parameter to the UE.

As shown in FIG. 5, a method for transmitting information is provided in an example of the present disclosure. The method is performed by UE and includes step 501.

Step 501: a relay discovery key request is transmitted to a discovery security management function via a base station, where the relay discovery key request is used to request a relay discovery security parameter corresponding to relay discovery, and the relay discovery key request is at least used for the discovery security management function to determine whether a security method assigned to the UE is used by the UE.

A 5G mobile communication system will be described as an example in the example, but the method of the example may not be limited to be applied to the 5G mobile communication system, for example, may be applied to a next-generation mobile communication system, which is not limited here.

The method of the example may be applied to a model A and a model B of 5G ProSe U2N discovery.

Here, the security method includes a security method based on a control plane and a security method based on a user plane used in a 5G ProSe discovery process.

The discovery security management function may be a core network element for security management in a ProSe.

The relay discovery security parameter may include at least one of the following associated with the relay discovery: a discovery key; algorithms for encryption and integrity protection of a discovery message; a timing parameter associated with a timer; etc.

In a possible implementation, a discovery security management function may be used to provide a security key, a security algorithm, etc. to relay UE and/or remote UE.

In a possible implementation, different types of discovery security management functions are associated with different security methods. Illustratively, one type of discovery security management function uses a security method based on a control plane, and another type of discovery security management function uses a security method based on a user plane.

In an example, the discovery security management function includes one of the following:
a PKMF; and
a DDNMF.

In a possible implementation, a security method based on a user plane is used by a PKMF.

In a possible implementation, a security method based on a control plane is used by a DDNMF.

The UE may be remote UE in a 5G ProSe, or relay UE in a 5G ProSe. The relay UE may be a U2N relay in the 5G ProSe.

In an example, the security method assigned to the UE is determined and indicated to the UE by the PCF of the UE.

The security method assigned to the UE may be determined by the PCF of the UE and indicated to the UE by the PCF of the UE.

In a possible implementation, a security method needing to be assigned to the UE is indicated to the UE by a PCF during registration of UE to a network.

In a possible implementation, an address of a discovery security management function of the UE and a discovery parameter are acquired from a PCF by UE during service authorization and information provision. The discovery parameter may include at least one of the following: an RSC; and a control plane security indicator. When the discovery parameter includes the control plane security indicator, it indicates that the UE is instructed by the PCF to use the security method based on the control plane. When the discovery parameter does not include the control plane security indicator, it indicates that the UE is instructed by the PCF to use the security method based on the user plane. The control plane security indicator is associated with the RSC.

The UE may select the discovery security management function after determining the security method assigned to the UE, and transmit a relay discovery key request to the discovery security management function. However, since the security method may be performed by not all UE according to the rule. For example, the control plane security indicator is provided by the RSC assigned to the UE. That is, the security method based on the control plane needs to be performed by the UE. But the security method based on the user plane may be still used by the UE. That is, the relay discovery key request is transmitted to the PKMF (which uses the security method based on the user plane) by the UE. Alternatively, the control plane security indicator is not provided by the RSC assigned to the UE. That is, the security method based on the user plane needs to be performed by the UE. But the security method based on the control plane may be still used by the UE. That is, the relay discovery key request is transmitted to the DDNMF (which uses the security method based on the control plane) by the UE. Thus, the security method of a relay service may not be executed correctly, thus affecting security of the relay service.

Here, the security method assigned to the UE based on the relay discovery key request may be determined by the security management function.

In a possible implementation, indication information for determining a security method assigned to the UE may be carried by a relay discovery key request.

The security method assigned to the UE may be explicitly or implicitly indicated by the indication information for determining the security method assigned to the UE.

In a possible implementation, indication information for determining the security method assigned to the UE may include an RSC assigned to the UE.

If the security method assigned to the UE is used by the UE, the security method supported by the security management function is consistent with the security method assigned to the UE.

If the security method assigned to the UE is not used by the UE, the security method supported by the security management function may not be consistent with the security method assigned to the UE.

The security method supported by the security management function may be compared with the security method assigned to the UE by the security management function, and whether the security method assigned to the UE is used by the UE is further determined by the security management function.

Thus, whether the security method assigned to the UE is used by the UE is determined by the discovery security management function based on the relay discovery key request. Thus, a security risk caused by the discovery security management function failing to support the security method assigned to the UE can be reduced, and relay service security can be improved.

In a possible implementation, the relay discovery key request further includes at least one of the following:
an ID of UE; and
security capability information of the UE, such as a security algorithm that may be supported.

Illustratively, a relay discovery key request may be transmitted to a discovery security management function (PKMF or DDNMF) of relay UE by the relay UE, and at least one of the following: an RSC, an ID of the relay UE, and security capability information of the relay UE may be carried by the relay discovery key request.

Illustratively, a relay discovery key request may be transmitted to a discovery security management function (PKMF or DDNMF) of the remote UE by remote UE, and at least one of the following: an RSC, an ID of the remote UE, and security capability information of the remote UE may be carried by the relay discovery key request.

Core network elements of the relay UE and the remote UE may be identical or different. That is, the discovery security management function of the relay UE and the discovery security management function of the remote UE may be the same network element or different network elements. A PCF of the relay UE and a PCF of the remote UE may be the same network element or different network elements.

In an example, an RSC of the relay discovery is carried in the relay discovery key request, the RSC is at least used to be transmitted to a PCF of the UE by the discovery security management function, and the security method assigned to the UE is indicated to the discovery security management function by the PCF based on the RSC.

In a possible implementation, an RSC of UE is carried in a security method check request and transmitted to a PCF of the UE by a discovery security management function.

In a possible implementation, a mapping table between different UE and PCF addresses is preset in a discovery security management function. For example, the discovery security management function may have a mapping table between IDs of the UE to the PCF addresses. The address of the PCF of the UE is determined by the discovery security management function based on the ID of the UE in the relay discovery key request, and an RSC carried by the UE in a relay discovery key request is further transmitted to the PCF by the discovery security management function.

The RSC for the UE may be configured by the PCF during service authorization and information configuration of the UE. The RSC may have a corresponding control plane security indicator indicating that a security method based on a control plane needs to be performed by the UE to which the RSC is assigned during discovery. If the RSC may not have the corresponding control plane security indicator, a security method based on a user plane needs to be performed by the UE to which the RSC is assigned during discovery.

A corresponding relation between each RSC and the corresponding security method may be saved by the PCF.

In a case where the RSC transmitted by the discovery security management function is received, the security method corresponding to the RSC may be determined by the PCF based on the corresponding relation between the RSC and the corresponding security method. The security method corresponding to the determined RSC is transmitted to the discovery security management function by the PCF by indication information, i.e. the discovery security management function is informed by the PCF of the security method assigned to the UE.

In a possible manner, indication information of a determined security method assigned to the UE is carried in a security method check response and transmitted to a security management function by a PCF.

In a possible manner, a discovery security management function carries an ID of UE in a security method check request when transmitting a security method check request carrying an RSC to a PCF of the UE, so as to indicate the UE corresponding to the security method requested.

In a possible manner, an ID of UE corresponding to a security method is carried by a PCF in a security method check response, so as to inform the UE corresponding to the security method.

A discovery security management function determines whether the discovery security management function supports the security method after receiving the security method assigned to the UE indicated by the PCF. If it is determined that a security method of the security management function is the same as the security method assigned to the UE indicated by the PCF, it may be determined that the security method assigned to the UE is used by the UE. If it is determined that the security method of the security management function is different from the security method assigned to the UE indicated by the PCF, it may be determined that the security method assigned to the UE is not used by the UE.

Thus, the security method assigned to the UE is determined by the PCF. Thus, accuracy of determination of the security method assigned to the UE is improved. Further, whether the security method assigned is used by the UE is determined. Thus, a security risk caused by the discovery security management function failing to support the security method assigned to the UE can be reduced, and relay service security can be improved.

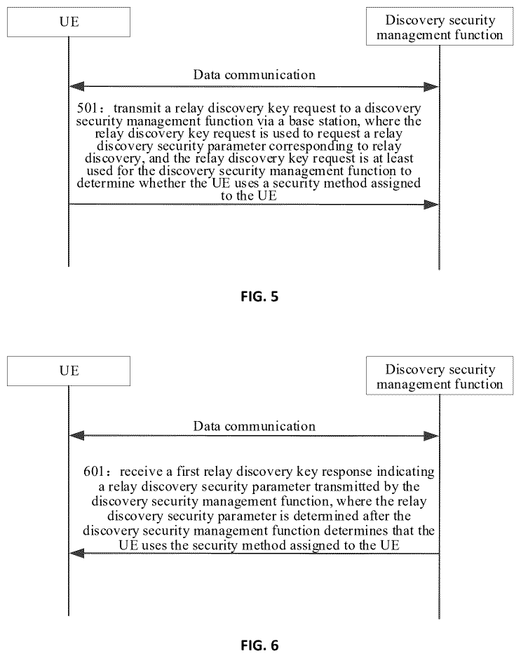

As shown in FIG. 6, a method for transmitting information is provided in an example of the present disclosure. The method is performed by UE and includes step 601.

Step 601: a first relay discovery key response indicating a relay discovery security parameter transmitted by the discovery security management function is received. The relay discovery security parameter is determined after the discovery security management function determines that the security method assigned to the UE is used by the UE.

Step 601 may be implemented separately or jointly in combination with step 501.

The discovery security management function may provide a security service to the UE after determining that the security method assigned to the UE is supported by the security management function, i.e. the security method assigned is used by the UE.

In a possible implementation, if a security method received by a discovery security management function from a PCF matches a role of the discovery security management function (i.e. a security method of the discovery security management function is the same as the security method assigned to UE received from the PCF, i.e. the security method assigned is used by the UE), a relay discovery security parameter of the UE may be determined by the discovery security management function, and the relay discovery security parameter may be transmitted to the UE by the discovery security management function.

In a possible implementation, a relay discovery security parameter includes, but not limited to, at least one of the following: a discovery key; algorithms for encryption and integrity protection of a discovery message; a timing parameter associated with a timer; etc.

In a possible implementation, the step that a relay discovery security parameter of the UE is determined, and a first relay discovery key response indicating the relay discovery security parameter is transmitted to the UE includes:
in a case where the UE is relay UE, the relay discovery security parameter of the relay UE is determined by a key management function, and the first relay discovery key response indicating the relay discovery security parameter is transmitted to the relay UE by the key management function.

Illustratively, if the security method received by the discovery security management function of the relay UE from the PCF matches the role of the discovery security management function of the relay UE (i.e. the relay UE uses the security method assigned), a discovery security material (i.e. relay discovery security parameter) is generated by the discovery security management function (5G PKMF or 5G DDNMF) of the relay UE for the relay UE. The algorithms for encryption and integrity protection of the discovery message broadcast between UE may also be selected by the discovery security management function of the relay UE based on the received security capability information of the relay UE. A first relay discovery key response message carrying the relay discovery security parameter is transmitted to the relay UE by the discovery security management function of the relay UE.

In a possible implementation, the step that a relay discovery security parameter of the UE is determined, and a first relay discovery key response indicating the relay discovery security parameter is transmitted to the UE includes:
in a case where the UE is remote UE, the relay discovery key request is transmitted to a key management function of relay UE;
the relay discovery security parameter transmitted by the key management function of the relay UE in response to the relay discovery key request is received; and
the relay discovery key response indicating the relay discovery security parameter is transmitted to the remote UE.

Illustratively, if the security method received by the discovery security management function of the remote UE from the PCF matches the role of the discovery security management function of the remote UE (i.e. the remote UE uses the security method assigned), a discovery security management function (5G PKMF or 5G DDNMF) of potential relay UE is positioned by the discovery security management function (5G PKMF or 5G DDNMF) of the remote UE according to a received RSC, and then a relay discovery key request message is forwarded to the discovery security management function of the relay UE by the discovery security management function of the remote UE.

A relay discovery key request message is received from the discovery security management function of the remote UE by the discovery security management function of the relay UE, and one piece of the relay UE in a domain of the discovery security management function is authorized by the discovery security management function of the relay UE to provide the relay service based on the received RCS.

Based on the received RSC, the relay discovery security parameter generated for the RSC is retrieved by the discovery security management function of the relay UE, and a response us made to the discovery security management function of the remote UE by the discovery security management function of the relay UE by the relay discovery key response message.

The relay discovery security parameter carried in the relay discovery key response message is forwarded to the remote UE by the discovery security management function of the remote UE.

The remote UE and the relay UE separately perform a discovery process on a PC5 to discover each other. It should be noted that if either of the remote UE and the relay UE fails to obtain the relay discovery security parameter, the UE may not transmit a protected discovery message or understand/verify a received discovery message, so as to successfully discover each other. That is, only UE that correctly uses a security method assigned to the RSC may discover each other.

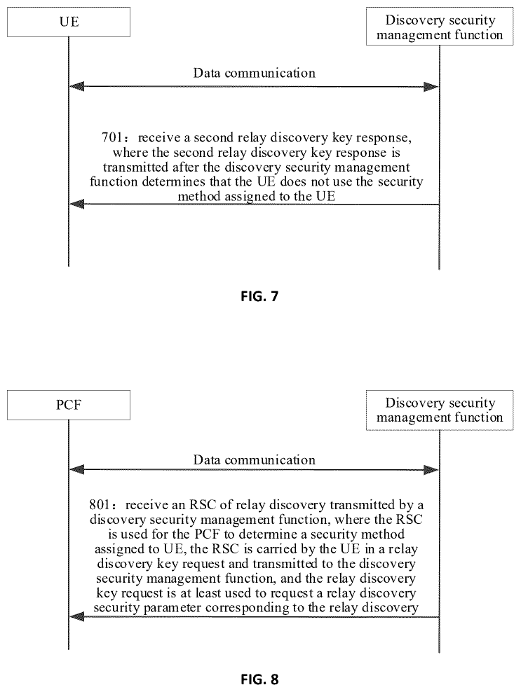

As shown in FIG. 7, a method for transmitting information is provided in an example of the present disclosure. The method is performed by UE and includes step 701.

Step 701: a second relay discovery key response is received. The second relay discovery key response is transmitted after the discovery security management function determines that the security method assigned to the UE is not used by the UE.

Step 701 may be implemented separately or jointly in combination with step 501 and/or step 601.

If the security method received by a discovery security management function from a PCF does not match a role of the discovery security management function (i.e. a security method of the discovery security management function is different from the security method assigned to the UE received from the PCF, i.e., the security method assigned is not used by the UE), the second relay discovery key response is transmitted to the UE by the discovery security management function, so as to explain the cause for failure in acquiring the relay discovery security parameter to the UE.

As shown in FIG. 8, a method for transmitting information is provided in an example of the present disclosure. The method is performed by a PCF and includes step 801.

Step 801: an RSC of relay discovery transmitted by a discovery security management function is received. The RSC is used for the PCF to determine a security method assigned to UE, the RSC is carried by the UE in a relay discovery key request and transmitted to the discovery security management function, and the relay discovery key request is at least used to request a relay discovery security parameter corresponding to the relay discovery.

A 5G mobile communication system will be described as an example in the example, but the method of the example may not be limited to be applied to the 5G mobile communication system, for example, may be applied to a next-generation mobile communication system, which is not limited here.

The method of the example may be applied to a model A and a model B of 5G ProSe U2N discovery.

Here, the security method includes a security method based on a control plane and a security method based on a user plane used in a 5G ProSe discovery process.

The discovery security management function may be a core network element for security management in a ProSe.

The relay discovery security parameter may include at least one of the following associated with the relay discovery: a discovery key; algorithms for encryption and integrity protection of a discovery message; a timing parameter associated with a timer; etc.

In a possible implementation, a discovery security management function may be used to provide a security key, a security algorithm, etc. to relay UE and/or remote UE.

In a possible implementation, different types of discovery security management functions are associated with different security methods. Illustratively, one type of discovery security management function uses a security method based on a control plane, and another type of discovery security management function uses a security method based on a user plane.

In an example, the discovery security management function includes one of the following:
a PKMF; and
a DDNMF.

In a possible implementation, a security method based on a user plane is used by a PKMF.

In a possible implementation, a security method based on a control plane is used by a DDNMF.

The UE may be remote UE in a 5G ProSe, or relay UE in a 5G ProSe. The relay UE may be a U2N relay in the 5G ProSe.

In an example, the security method assigned to the UE is determined and indicated to the UE by the PCF of the UE.

The security method assigned to the UE may be determined by the PCF of the UE and indicated to the UE by the PCF of the UE.

In a possible implementation, a security method needing to be assigned to the UE is indicated to the UE by a PCF during registration of UE to a network.

In a possible implementation, an address of a discovery security management function of the UE and a discovery parameter are acquired from a PCF by UE during service authorization and information provision. The discovery parameter may include at least one of the following: an RSC; and a control plane security indicator. When the discovery parameter includes the control plane security indicator, it indicates that the UE is instructed by the PCF to use the security method based on the control plane. When the discovery parameter does not include the control plane security indicator, it indicates that the UE is instructed by the PCF to use the security method based on the user plane. The control plane security indicator is associated with the RSC.

The UE may select the discovery security management function after determining the security method assigned to the UE, and transmit a relay discovery key request to the discovery security management function. However, since the security method may be performed by not all UE according to the rule. For example, the control plane security indicator is provided by the RSC assigned to the UE. That is, the security method based on the control plane needs to be performed by the UE. But the security method based on the user plane may be still used by the UE. That is, the relay discovery key request is transmitted to the PKMF (which uses the security method based on the user plane) by the UE. Alternatively, the control plane security indicator is not provided by the RSC assigned to the UE. That is, the security method based on the user plane needs to be performed by the UE. But the security method based on the control plane may be still used by the UE. That is, the relay discovery key request is transmitted to the DDNMF (which uses the security method based on the control plane) by the UE. Thus, the security method of a relay service may not be executed correctly, thus affecting security of the relay service.

Here, the security method assigned to the UE based on the relay discovery key request may be determined by the security management function.

In a possible implementation, indication information for determining a security method assigned to the UE may be carried by a relay discovery key request.

The security method assigned to the UE may be explicitly or implicitly indicated by the indication information for determining the security method assigned to the UE.

In a possible implementation, indication information for determining the security method assigned to the UE may include an RSC assigned to the UE.

If the security method assigned to the UE is used by the UE, the security method supported by the security management function is consistent with the security method assigned to the UE.

If the security method assigned to the UE is not used by the UE, the security method supported by the security management function may not be consistent with the security method assigned to the UE.

The security method supported by the security management function may be compared with the security method assigned to the UE by the security management function, and whether the security method assigned to the UE is used by the UE is further determined by the security management function.

Thus, whether the security method assigned to the UE is used by the UE is determined by the discovery security management function based on the relay discovery key request. Thus, a security risk caused by the discovery security management function failing to support the security method assigned to the UE can be reduced, and relay service security can be improved.

In a possible implementation, the relay discovery key request further includes at least one of the following:
an ID of UE; and
security capability information of the UE, such as a security algorithm that may be supported.

Illustratively, a relay discovery key request may be transmitted to a discovery security management function (PKMF or DDNMF) of relay UE by the relay UE, and at least one of the following: an RSC, an ID of the relay UE, and security capability information of the relay UE may be carried by the relay discovery key request.

Illustratively, a relay discovery key request may be transmitted to a discovery security management function (PKMF or DDNMF) of the remote UE by remote UE, and at least one of the following: an RSC, an ID of the remote UE, and security capability information of the remote UE may be carried by the relay discovery key request.

Core network elements of the relay UE and the remote UE may be identical or different. That is, the discovery security management function of the relay UE and the discovery security management function of the remote UE may be the same network element or different network elements. A PCF of the relay UE and a PCF of the remote UE may be the same network element or different network elements.

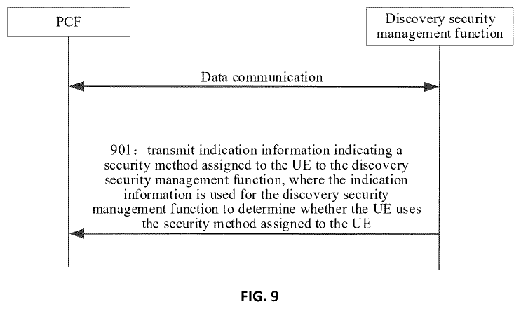

As shown in FIG. 9, a method for transmitting information is provided in an example of the present disclosure. The method is performed by a PCF and includes step 901.

Step 901: indication information indicating a security method assigned to the UE is transmitted to the discovery security management function. The indication information is used for the discovery security management function to determine whether the security method assigned to the UE is used by the UE.

Step 901 may be implemented separately or jointly in combination with step 801.

In a possible implementation, an RSC of UE is carried in a security method check request and transmitted to a PCF of the UE by a discovery security management function.

In a possible implementation, a mapping table between different UE and PCF addresses is preset in a discovery security management function. For example, the discovery security management function may have a mapping table between IDs of the UE to the PCF addresses. The address of the PCF of the UE is determined by the discovery security management function based on the ID of the UE in the relay discovery key request, and an RSC carried by the UE in a relay discovery key request is further transmitted to the PCF by the discovery security management function.

The RSC for the UE may be configured by the PCF during service authorization and information configuration of the UE. The RSC may have a corresponding control plane security indicator indicating that a security method based on a control plane needs to be performed by the UE to which the RSC is assigned during discovery. If the RSC may not have the corresponding control plane security indicator, a security method based on a user plane needs to be performed by the UE to which the RSC is assigned during discovery.

A corresponding relation between each RSC and the corresponding security method may be saved by the PCF.

In a case where the RSC transmitted by the discovery security management function is received, the security method corresponding to the RSC may be determined by the PCF based on the corresponding relation between the RSC and the corresponding security method. The security method corresponding to the determined RSC is transmitted to the discovery security management function by the PCF by indication information, i.e. the discovery security management function is informed by the PCF of the security method assigned to the UE.

In a possible manner, indication information of a determined security method assigned to the UE is carried in a security method check response and transmitted to a security management function by a PCF.

In a possible manner, a discovery security management function carries an ID of UE in a security method check request when transmitting a security method check request carrying an RSC to a PCF of the UE, so as to indicate the UE corresponding to the security method requested.

In a possible manner, an ID of UE corresponding to a security method is carried by a PCF in a security method check response, so as to inform the UE corresponding to the security method.

A discovery security management function determines whether the discovery security management function supports the security method after receiving the security method assigned to the UE indicated by the PCF. If it is determined that a security method of the security management function is the same as the security method assigned to the UE indicated by the PCF, it may be determined that the security method assigned to the UE is used by the UE. If it is determined that the security method of the security management function is different from the security method assigned to the UE indicated by the PCF, it may be determined that the security method assigned to the UE is not used by the UE.

Thus, the security method assigned to the UE is determined by the PCF. Thus, accuracy of determination of the security method assigned to the UE is improved. Further, whether the security method assigned is used by the UE is determined. Thus, a security risk caused by the discovery security management function failing to support the security method assigned to the UE can be reduced, and relay service security can be improved.

It should be noted that the method of the PCF corresponds to the above example of a UE side. For example, a network-side device and the UE need to simultaneously enter or stop a discontinuous reception (DRX) cycle to maintain synchronization, and settings of the timer, etc. are synchronously implemented. Thus, the same explanation or feature is not repeated one by one, and reference may be made to the above example.

After the security method assigned to the UE is indicated by the PCF, the method performed by the discovery security management function is consistent with the above method for transmitting information performed by a discovery security management function side, and the method performed by the UE is consistent with the above method for transmitting information performed by the UE side, which is not repeated here.

In order to further explain any example of the present disclosure, a particular example is provided below.

A method for transmitting information according to the example is suitable for a model A and a model B of ProSe U2N discovery.

Here, it is assumed that a mapping table between an RSC and an address of a 5G PKMF/DDNMF of a potential U2N relay of a relay service represented by the RSC is configured in a 5G PKMF/DDNMF of remote UE.

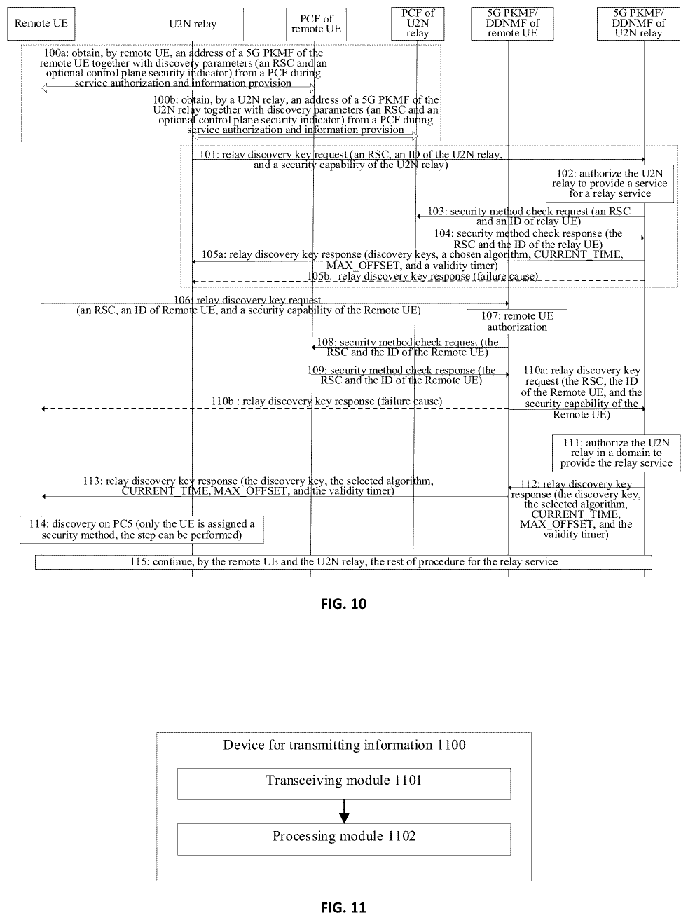

As shown in FIG. 10, a method for transmitting information specifically includes steps 100-115.

Step 100 includes step 100a or step 100b.

step 100a: an address of a 5G PKMF of remote UE and discovery parameters (an RSC together with an optional control plane security indicator) are acquired from a PCF by the remote UE during service authorization and information provision.

Step 100b: an address of a 5G PKMF of a U2N relay and discovery parameters (an RSC together with an optional control plane security indicator) are obtained from a PCF by the U2N relay during service authorization and information provision.

Step 101: based on availability of the CP security indicator, a relay discovery key request message determines to be transmitted to the 5G PKMF (if no CP security indicator is assigned to the requested RSC) or a 5G DDNMF (if the CP security indicator is assigned to the requested RSC) of the U2N relay by the U2N relay. The message includes the requested RSC of a relay service indicating execution of discovery, an ID of the U2N relay, and a security capability of the U2N relay.

Step 102: the 5G PKMF/DDNMF of the U2N relay verifies (for example, by unified data management (UDM) or the PCF) that the U2N relay is authorized to provide a service for the relay service according to the received RSC.

Step 103: a security method check request is transmitted to the PCF of the U2N relay by the 5G PKMF/DDNMF of the U2N relay, so as to check a security method assigned to the RSC. The request at least includes the RSC and the ID of the relay UE.

Step 104: the security method assigned to the RSC is checked by the PCF of the U2N relay according to the received RSC and the ID of the relay UE, and a security method check response is transmitted to the 5G PKMF/DDNMF of the U2N relay by the PCF of the U2N relay, so as to inform the 5G PKMF/DDNMF of the U2N relay of the security method.

Step 105 includes step 105a or step 105b.

Step 105a: if the security method received from the PCF matches a role of the 5G PKMF/DDNMF of the U2N relay, a discovery security material is generated for the U2N relay by the 5G PKMF/DDNMF of the U2N relay. Based on the received security capability of the U2N relay, algorithms for encryption and integrity protection of a discovery message broadcast between UE are also selected by the 5G PKMF/DDNMF of the U2N relay. Then, a relay discovery key response message is transmitted to the U2N relay by the 5G PKMF/DDNMF of the U2N relay.

Step 105b: if the security method received from the PCF does not match the role of the 5G PKMF/DDNMF of the U2N relay, any discovery security material is not generated for the U2N relay by the 5G PKMF/DDNMF of the U2N relay, and a failure cause which indicating that a relay discovery key response message fails to send to the U2N relay is transmitted to the U2N relay by the 5G PKMF/DDNMF of the U2N relay.

Step 106: a relay discovery key request message is transmitted to the 5G PKMF/DDNMF of the remote UE by the remote UE. The message includes an RSC of a relay service indicating execution of discovery, an ID of the remote UE, and a security capability of the remote UE.

Step 107: the 5G PKMF/DDNMF of the remote UE verifies (for example, by a UDM or a PCF) that the remote UE is entitled to request the relay service indicated by the RSC.

Step 108: a security method check request is transmitted to the PCF of the remote UE by the 5G PKMF/DDNMF of the remote UE, so as to check the security method assigned to the RSC. The request at least includes the RSC and the ID of the remote UE.

Step 109: the security method assigned to the RSC is checked by the PCF of the remote UE according to the received RSC and the ID of the remote UE, and a security method check response is transmitted to the 5G PKMF/DDNMF of the remote UE by the PCF of the remote UE, so as to inform the 5G PKMF/DDNMF of the remote UE of the security method.

Step 110 includes step 110a or step 110b.

Step 110a: if the security method received from the PCF matches a role of the 5G PKMF/DDNMF of the remote UE, the 5G PKMF/DDNMF of the potential U2N relay is positioned by the 5G PKMF/DDNMF of the remote UE according to the received RSC, and then the relay discovery key request message is forwarded to the 5G PKMF/DDNMF of the U2N relay by the 5G PKMF/DDNMF of the remote UE.

Step 110b: if the security method received from the PCF does not match the role of the 5G PKMF/DDNMF of the remote UE, the relay discovery key request message is not forwarded to the 5G PKMF/DDNMF of the U2N relay by the 5G PKMF/DDNMF of the remote UE, but a response message of a relay discovery key is transmitted to the U2N relay by the 5G PKMF/DDNMF of the remote UE, so as to explain a failure cause.

Step 111: if the relay discovery key request message is received from the 5G PKMF/DDNMF of the remote UE, the 5G PKMF/DDNMF of the U2N relay authorizes that a service may be provided by one of U2N relays in a domain of the 5G PKMF/DDNMF of the U2N relay for the received RSC.

Step 112: based on the received RSC, the discovery security material generated for the RSC in step 105a is retrieved by the 5G PKMF/DDNMF of the U2N relay and a response is made to the 5G PKMF of the remote UE by the 5G PKMF/DDNMF of the U2N relay by the relay discovery key response message.

Step 113: the relay discovery key response message (including a discovery security material, a chosen algorithm, etc.) is forwarded to the remote UE by the 5G PKMF/DDNMF of the remote UE.

Step 114: the U2N relay and the remote UE separately perform a discovery process on PC5 to discover each other. It should be noted that if one or two pieces of UE fail to obtain the discovery security material in step 105b and/or step 110b, the UE may not transmit the protected discovery message or understand/verify the received message. The UE may not successfully discover each other by the discovery message. That is, only the UE that correctly uses the security method assigned to the RSC may discover each other.

Step 115: remaining processes of the relay service are continued by the remote UE and the U2N relay.

As shown in FIG. 11, a device for transmitting information 1100 is provided in an example of the present disclosure. The device is set in a discovery security management function and includes a transceiving module 1101 and a processing module 1102.

The transceiving module 1101, configured to receive a relay discovery key request transmitted by UE via a base station, where the relay discovery key request is used to request a relay discovery security parameter corresponding to relay discovery.

The processing module 1102, configured to determine, at least based on the relay discovery key request, whether the UE uses a security method assigned to the UE.

In an example, the transceiving module 1101 is further configured to transmit an RSC associated with the relay discovery to a PCF of the UE, where the RSC is carried in the relay discovery key request;
the transceiving module 1101 is further configured to receive indication information indicating the security method assigned to the UE and transmitted by the PCF to the discovery security management function in response to the RSC; and
the processing module 1102 is specifically configured to determine, based on a security method associated with the discovery security management function, whether the UE uses the security method assigned to the UE.

In an example,
the processing module 1102 is further configured to determine a relay discovery security parameter of the UE in response to determining that the UE uses the security method assigned to the UE; and
the transceiving module 1101 is further configured to transmit a first relay discovery key response indicating the relay discovery security parameter to the UE.

In an example,
the transceiving module 1101 is further configured to transmit a second relay discovery key response to the UE in a case where the UE does not use the security method assigned to the UE, where the second relay discovery key response is used to indicate that the UE does not use the security method assigned to the UE.

In an example, the security method assigned to the UE is determined and indicated to the UE by the PCF of the UE.

In an example, the discovery security management function includes one of the following:
a PKMF; and
a DDNMF.

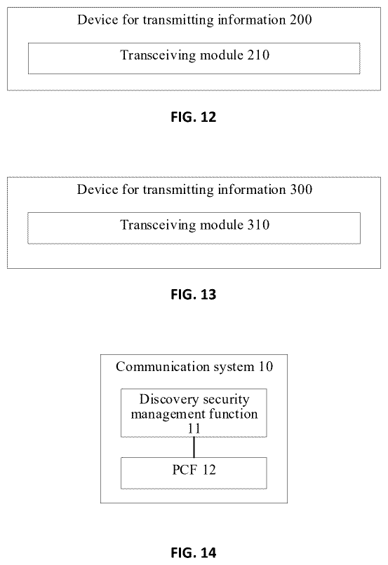

As shown in FIG. 12, a device for transmitting information 200 is provided in an example of the present disclosure. The device is set in UE and includes a transceiving module 210.

The transceiving module 210 is configured to transmit a relay discovery key request to a discovery security management function via a base station, where the relay discovery key request is used to request a relay discovery security parameter corresponding to relay discovery, and the relay discovery key request is at least used for the discovery security management function to determine whether the UE uses a security method assigned to the UE.

In an example, an RSC of the relay discovery is carried in the relay discovery key request, the RSC is at least used to be transmitted to a PCF of the UE by the discovery security management function, and the security method assigned to the UE is indicated to the discovery security management function by the PCF based on the RSC.

In an example, the transceiving module is further configured to receive a first relay discovery key response indicating a relay discovery security parameter transmitted by the discovery security management function, where the relay discovery security parameter is determined after the discovery security management function determines that the security method assigned to the UE.

In an example,
the transceiving module 210 is further configured to receive a second relay discovery key response, where the second relay discovery key response is transmitted after the discovery security management function determines that the UE does not use the security method assigned to the UE.

In an example, the security method assigned to the UE is determined and indicated to the UE by the PCF of the UE.

In an example, the discovery security management function includes one of the following:
a PKMF; and
a DDNMF.

As shown in FIG. 13, a device for transmitting information 300 is provided in an example of the present disclosure. The device is set in a PCF and includes a transceiving module 310.

The transceiving module 310, configured to receive an RSC of relay discovery transmitted by a discovery security management function, where the RSC is used for the PCF to determine a security method assigned to UE, the RSC is carried by the UE in a relay discovery key request and transmitted to the discovery security management function, and the relay discovery key request is at least used to request a relay discovery security parameter corresponding to the relay discovery.

In an example,
the transceiving module 310 is further configured to transmit indication information indicating a security method assigned to the UE to the discovery security management function, where the indication information is used for the discovery security management function to determine whether the UE uses the security method assigned to the UE.

In an example, the security method assigned to the UE is determined and indicated to the UE by the PCF of the UE.

A communication device is provided in an example of the present disclosure. The communication device includes:
a processor; and
a memory that stores processor-executable instructions.

The processor is configured to implement the method for transmitting information of any example of the present disclosure when running the executable instructions.

In an example, a communication device may include, but not limited to, at least one of UE and a network device. The network device here may include a core network or an access network device. The access network device here may include a base station. The core network may include an access and mobility management function (AMF) and a session management function (SMF).

The processor may include various types of storage media. The storage media are non-temporary computer storage media that may continue to memorize information stored on the storage media after power failure of UE.

The processor may be connected to the memory by a bus, and is used to read an executable program stored on the memory, for example, at least one of the methods shown in FIGS. 2-9.

A computer storage medium is further provided in an example of the present disclosure. The computer storage medium stores a computer-executable program, and the executable program, when performed by a processor, implements the method for transmitting information of any example of the present disclosure, for example, at least one of the methods shown in FIGS. 2-6.

For the device or the storage medium in the above example, a specific mode for each module to perform an operation has been described in detail in the example corresponding to the method, which will not be repeated here.

Corresponding to the above examples of the discovery security management function side, the UE side and the PCF side, as shown in FIG. 14, a communication system 10 is further provided in an example of the present disclosure. It should be noted that the communication system corresponds to the above examples of the discovery security management function side and the PCF side. Thus, the same explanation or feature is not repeated one by one, and reference may be made to the above examples.

The communication system 10 includes: a discovery security management function 11 and a PCF 12.

The discovery security management function 11 is used to receive a relay discovery key request transmitted by UE via a base station, where the relay discovery key request is used to request a relay discovery security parameter corresponding to relay discovery; and determine, at least based on the relay discovery key request, whether a security method assigned to the UE is used by the UE;
the discovery security management function is specifically used to transmit an RSC associated with the relay discovery to a PCF of the UE, where the RSC is carried in the relay discovery key request; and
the PCF 12 is used to receive the RSC of the relay discovery transmitted by the discovery security management function, and determine, based on the RSC, the security method assigned to the UE.

According to a first aspect of the present disclosure, a method for transmitting information is provided. The method is performed by a discovery security management function and includes:
receiving a relay discovery key request transmitted by user equipment (UE) via a base station, where the relay discovery key request is used to request a relay discovery security parameter corresponding to relay discovery; and
determining, at least based on the relay discovery key request, whether the UE uses a security method assigned to the UE.

In an example, determining, at least based on the relay discovery key request, whether the UE uses the security method assigned to the UE includes:
transmitting a relay service code (RSC) associated with the relay discovery to a policy control function (PCF) of the UE, where the RSC is carried in the relay discovery key request; receiving indication information indicating the security method assigned to the UE and transmitted by the PCF to the discovery security management function in response to the RSC; and
   determining, based on a security method associated with the discovery security management function, whether the UE uses the security method assigned to the UE.

In an example, the method further includes:
determining a relay discovery security parameter of the UE in response to determining that the UE uses the security method assigned to the UE, and transmitting a first relay discovery key response indicating the relay discovery security parameter to the UE.

In an example, the method further includes:
transmitting a second relay discovery key response to the UE in a case where the UE does not use the security method assigned to the UE, where the second relay discovery key response is used to indicate that the UE does not use the security method assigned to the UE.

In an example, the security method assigned to the UE is determined and indicated to the UE by the PCF of the UE.

In an example, the discovery security management function includes one of the following:
a proximity-based services key management function (PKMF); and
a direct discovery name management function (DDNMF).

According to a second aspect of the present disclosure, a method for transmitting information is provided. The method is performed by UE and includes:
transmitting a relay discovery key request to a discovery security management function via a base station, where the relay discovery key request is used to request a relay discovery security parameter corresponding to relay discovery, and the relay discovery key request is at least used for the discovery security management function to determine whether the UE uses a security method assigned to the UE.

In an example, the relay discovery key request, the RSC is at least used to be transmitted to a PCF of the UE by the discovery security management function, and the security method assigned to the UE is indicated to the discovery security management function by the PCF based on the RSC.

In an example, the method further includes:
receiving a first relay discovery key response indicating a relay discovery security parameter transmitted by the discovery security management function, where the relay discovery security parameter is determined by the discovery security management function in a case where the UE uses the security method assigned to the UE.

In an example, the method further includes:
receiving a second relay discovery key response, where the second relay discovery key response is transmitted by the discovery security management function in a case where the UE does not use the security method assigned to the UE.

In an example, the security method assigned to the UE is determined and indicated to the UE by the PCF of the UE.

In an example, the discovery security management function includes one of the following:
a PKMF; and
a DDNMF.

According to a third aspect of the present disclosure, a method for transmitting information is provided. The method is performed by a PCF and includes:
receiving an RSC of relay discovery transmitted by a discovery security management function, where the RSC is used for the PCF to determine a security method assigned to UE, the RSC is carried by the UE in a relay discovery key request and transmitted to the discovery security management function, and the relay discovery key request is at least used to request a relay discovery security parameter corresponding to the relay discovery.

In an example, the method further includes:
transmitting indication information indicating a security method assigned to the UE to the discovery security management function, where the indication information is used for the discovery security management function to determine whether the UE uses the security method assigned to the UE.

In an example, the security method assigned to the UE is determined and indicated to the UE by the PCF of the UE.

According to a fourth aspect of the present disclosure, a device for transmitting information is provided. The device is set in a discovery security management function and includes:
a transceiving module, configured to receive a relay discovery key request transmitted by UE via a base station, where the relay discovery key request is used to request a relay discovery security parameter corresponding to relay discovery; and
a processing module, configured to determine, at least based on the relay discovery key request, whether the UE uses a security method assigned to the UE.

In an example, the transceiving module is further configured to transmit an RSC associated with the relay discovery to a PCF of the UE, where the RSC is carried in the relay discovery key request;
the transceiving module is further configured to receive indication information indicating the security method assigned to the UE and transmitted by the PCF to the discovery security management function in response to the RSC; and
the processing module is specifically configured to determine, based on a security method associated with the discovery security management function, whether the UE uses the security method assigned to the UE.

### In an Example,

the processing module is further configured to determine a relay discovery security parameter of the UE in response to determining that the UE uses the security method assigned to the UE; and
the transceiving module is further configured to transmit a first relay discovery key response indicating the relay discovery security parameter to the UE.

In an example,
the transceiving module is further configured to transmit a second relay discovery key response to the UE in a case where the UE does not use the security method assigned to the UE, where the second relay discovery key response is used to indicate that the UE does not use the security method assigned to the UE.

In an example, the security method assigned to the UE is determined and indicated to the UE by the PCF of the UE.

In an example, the discovery security management function includes one of the following:
a PKMF; and
a DDNMF.

According to a fifth aspect of the present disclosure, a device for transmitting information is provided. The device is set in UE and includes:
a transceiving module, configured to transmit a relay discovery key request to a discovery security management function via a base station, where the relay discovery key request is used to request a relay discovery security parameter corresponding to relay discovery, and the relay discovery key request is at least used for the discovery security management function to determine whether the UE uses a security method assigned to the UE.

In an example, an RSC of the relay discovery is carried in the relay discovery key request, the RSC is at least used to be transmitted to a PCF of the UE by the discovery security management function, and the security method assigned to the UE to the discovery security management function by the PCF based on the RSC.

In an example, the transceiving module is further configured to receive a first relay discovery key response indicating a relay discovery security parameter transmitted by the discovery security management function, where the relay discovery security parameter is determined by the discovery security management function in a case where the UE uses the security method assigned to the UE.

In an example,
the transceiving module is further configured to receive a second relay discovery key response, where the second relay discovery key response is transmitted by the discovery security management function in a case where the UE does not use the security method assigned to the UE.

In an example, the security method assigned to the UE is determined and indicated to the UE by the PCF of the UE.

In an example, the discovery security management function includes one of the following:
a PKMF; and
a DDNMF.

According to a sixth aspect of the present disclosure, a device for transmitting information is provided. The device is set in a PCF and includes:
a transceiving module, configured to receive an RSC of relay discovery transmitted by a discovery security management function, where the RSC is used for the PCF to determine a security method assigned to UE, the RSC is carried by the UE in a relay discovery key request and transmitted to the discovery security management function, and the relay discovery key request is at least used to request a relay discovery security parameter corresponding to the relay discovery.

In an example,
the transceiving module is further configured to transmit indication information indicating a security method assigned to the UE to the discovery security management function, where the indication information is used for the discovery security management function to determine whether the UE uses the security method assigned to the UE.

In an example, the security method assigned to the UE is determined and indicated to the UE by the PCF of the UE.

According to a seventh aspect of the present disclosure, a communication device is provided. The communication device includes:
a processor; and
a memory that stores processor-executable instructions, where
the processor is configured to implement the method for transmitting information of the first aspect, the second aspect or the third aspect when running the executable instructions.

According to an eighth aspect of the present disclosure, a computer storage medium is provided. The computer storage medium stores a computer-executable program, and the computer-executable program, when performed by a processor, implements the method for transmitting information of the first aspect, the second aspect or the third aspect.

The technical solution according to the example of the present disclosure may have the following beneficial effects.

In the example of the present disclosure, the discovery security management function receives the relay discovery key request transmitted by the UE via the base station, where the relay discovery key request is used to request the relay discovery security parameter corresponding to the relay discovery; and determines, at least based on the relay discovery key request, whether the security method assigned to the UE is used by the UE. Thus, whether the security method assigned to the UE is used by the UE is determined by the discovery security management function based on the relay discovery key request. Thus, a security risk caused by the discovery security management function failing to support the security method assigned to the UE can be reduced, and relay service security can be improved.

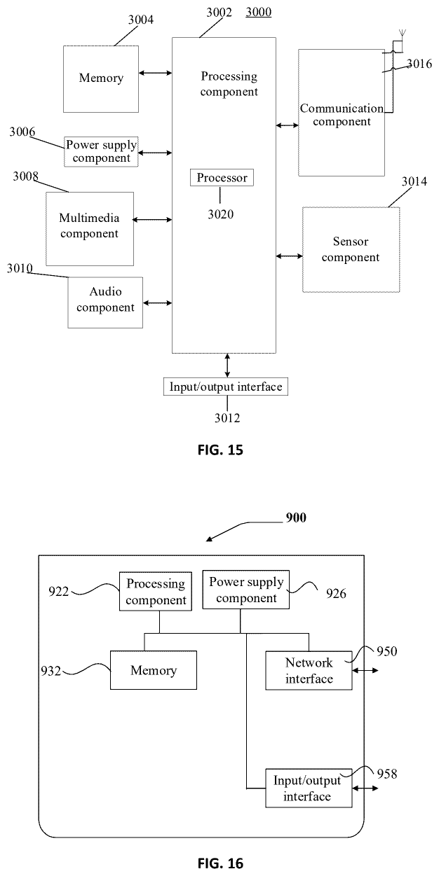

FIG. 15 is a block diagram of UE 3000 shown according to an example. for example, the UE 3000 may be a mobile phone, a computer, digital broadcast UE, a message transmitting and receiving device, a game console, a tablet device, a medical device, a fitness device, a personal digital assistant, etc.

With reference to FIG. 15, the UE 3000 may include one or more of the following components: a processing component 3002, a memory 3004, a power supply component 3006, a multimedia component 3008, an audio component 3010, an input/output (I/O) interface 3012, a sensor component 3014 and a communication component 3016.

Overall operations of the UE 3000, such as operations associated with display, phone calls, data communications, camera operations and recording operations, are generally controlled by the processing component 3002. The processing component 3002 may include one or more processors 3020 to execute instructions to complete all or some of steps of the method described above. Further, the processing component 3002 may include one or more modules that facilitate interaction between the processing component 3002 and other components. For example, the processing component 3002 may include a multimedia module, so as to facilitate interaction between the multimedia component 3008 and the processing component 3002.

The memory 3004 is configured to store any type of data to support operations at the UE 3000. Instances of such data include instructions, contact data, phone book data, messages, pictures, videos, etc., for any application or method operated on the UE 3000. The memory 3004 may be implemented by any type of volatile or non-volatile storage device, or a combination of any type of volatile or non-volatile storage device, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

Power is provided by the power supply component 3006 for various components of the UE 3000. The power supply component 3006 may include a power management system, one or more power supplies, and other components associated with generation, management and distribution of power for the UE 3000.

The multimedia component 3008 includes a screen that provides an output interface between the UE 3000 and a user. In some examples, a screen may include a liquid crystal display (LCD) and a touch panel (TP). If the screen includes the TP, the screen may be implemented as a touch screen to receive an input signal from a user. The TP includes one or more touch sensors to sense touching, swiping, and gestures on the TP. A boundary of a touch or swiping action may be sensed by the touch sensor, and duration and pressure associated with a touching or swiping operation may be further detected by the touch sensor. In some examples, a multimedia component 3008 includes a front-facing camera and/or a rear-facing camera. When the UE 3000 is in an operation mode, such as a photographing mode or a video mode, external multimedia data may be received by the front-facing camera and/or the rear-facing camera. Each front-facing camera and each rear-facing camera may be a fixed optical lens system or have a focal length and an optical zoom capability.

The audio component 3010 is configured to output and/or input an audio signal. For example, the audio component 3010 includes a microphone (MIC). The MIC is configured to receive an external audio signal when the UE 3000 is in an operating mode, such as a call mode, a recording mode, and a voice recognition mode. The received audio signal may be further stored in the memory 3004 or transmitted via the communication component 3016. In some examples, an audio component 3010 further includes a loudspeaker for outputting an audio signal.

An interface is provided by the I/O interface 3012 between the processing component 3002 and a peripheral interface module. The peripheral interface module described above may be a keyboard, a click wheel, a button, etc. The button may include, but not limited to, a home button, a volume button, a start button, and a lock button.

The sensor component 3014 includes one or more sensors used to provide state assessments of various aspects for the UE 3000. For example, an on/off state of the UE 3000, and a relative positioning effect of components may be detected by the sensor component 3014. For example, the component is a display and a keypad of the UE 3000. A change in position of the UE 3000 or a component of the UE 3000, presence or absence of the user making contact with the UE 3000, orientation or acceleration/deceleration of the UE 3000, and a change in temperature of the UE 3000 may be further detected by the sensor component 3014. The sensor component 3014 may include a proximity sensor configured to detect presence of nearby objects in the absence of any physical contact. The sensor component 3014 may further include a light sensor, such as a complementary metal-oxide-semiconductor (CMOS) image sensor or a charge coupled device (CCD) image sensor, used in imaging applications. In some examples, a sensor component 3014 may further include an acceleration sensor, a gyro sensor, a magnetic sensor, a pressure sensor, or a temperature sensor.

The communication component 3016 is configured to facilitate communication between the UE 3000 and other devices in a wired or wireless manner. A wireless network based on a communication standard, such as wireless fidelity (WiFi), 4G, 5G, or a combination of the WiFi, the 4G and the 5G, may be accessed by the UE 3000. In an example, a broadcast signal or broadcast related information from an external broadcast management system is received by a communication component 3016 via a broadcast channel. In an example, a communication component 3016 further includes a near field communication (NFC) module to facilitate short range communication. For example, the NFC module may be implemented on the basis of a radio frequency identification (RFID) technology, an infrared data association (IrDA) technology, a ultra wide band (UWB) technology, a Bluetooth (BT) technology, and other technologies.

In an example, a UE 3000 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, micro-processors, or other electronic elements, and is used to perform the method described above.

In an example, a non-transitory computer-readable storage medium including instructions is further provided, such as a memory 3004 including instructions. The instructions are executable by a processor 3020 of UE 3000, so as to complete the method described above. for example, the non-transitory computer-readable storage medium may be a ROM, a random access memory (RAM), a compact disc read-only memory (CD-ROM), a magnetic tape, a floppy disk, an optical data storage device, etc.

As shown in FIG. 16, a structure of a base station is shown in an example of the present disclosure. For example, the base station 900 may be provided as a network-side device. With reference to FIG. 16, the base station 900 includes a processing component 922. The processing component further includes one or more processors, and memory resources represented by a memory 932, which are used to store instructions, for example, an application, executable by the processing component 922. The application stored in the memory 932 may include one or more modules, each corresponding to a group of instructions. Further, the processing component 922 is configured to execute the instructions, so as to implement any of the above methods previously applied to the base station.

The base station 900 may further include a power supply component 926 configured to perform power management for the base station 900, a wired or wireless network interface 950 configured to connect the base station 900 to a network, and an input/output (I/O) interface 958. The base station 900 may operate an operating system stored in the memory 932, such as Windows Server™, Mac OS X™, Unix™, Linux™, FreeBSD™, or the like.

Those skilled in the art could easily conceive of other implementation solutions of the present disclosure upon consideration of the description and the invention disclosed in the implementation. The present disclosure is intended to cover any variations, uses or adaptive changes of the present disclosure, which follow the general principles of the present disclosure and include common general knowledge or customary technical means, which is not disclosed in the present disclosure, in the technical field. The description and the examples are merely to be regarded as illustrative, and the true scope and spirit of the present disclosure are indicated by the appended claims.

It should be understood that the present disclosure is not limited to a precise structure which has been described above and illustrated in the accompanying drawings, and can have various modifications and changes without departing from the scope of the present disclosure. The scope of the present disclosure is limited by the appended claims merely.

1. A method for transmitting information, performed by a discovery security management function, comprising:
receiving a relay discovery key request transmitted by user equipment (UE) via a base station, wherein the relay discovery key request is used to request a relay discovery security parameter corresponding to relay discovery; and
determining, based on the relay discovery key request, whether the UE uses a security method assigned to the UE.

2. The method according to claim 1, wherein determining, based on the relay discovery key request, whether the UE uses the security method assigned to the UE comprises:
transmitting a relay service code (RSC) associated with the relay discovery to a policy control function (PCF) of the UE, wherein the RSC is carried in the relay discovery key request;
receiving indication information indicating the security method assigned to the UE and transmitted by the PCF to the discovery security management function based on the RSC; and
determining, based on a security method associated with the discovery security management function, whether the UE uses the security method assigned to the UE.

3. The method according to claim 1, further comprising:
determining a relay discovery security parameter of the UE in response to determining that the UE uses the security method assigned to the UE, and transmitting a first relay discovery key response indicating the relay discovery security parameter to the UE.

4. The method according to claim 1, further comprising:
transmitting a second relay discovery key response to the UE in a case where the UE does not use the security method assigned to the UE, wherein the second relay discovery key response is used to indicate that the UE does not use the security method assigned to the UE.

5. The method according to claim 1, wherein the security method assigned to the UE is determined and indicated to the UE by a policy control function (PCF) of the UE.

6. The method according to claim 1, wherein the discovery security management function comprises one of:
a proximity-based services key management function (PKMF); and
a direct discovery name management function (DDNMF).

7. A method for transmitting information, performed by user equipment (UE), comprising:
transmitting a relay discovery key request to a discovery security management function via a base station, wherein the relay discovery key request is used to request a relay discovery security parameter corresponding to relay discovery, and the relay discovery key request is at least used for the discovery security management function to determine whether the UE uses a security method assigned to the UE.

8. The method according to claim 7, wherein
a relay service code (RSC) of the relay discovery is carried in the relay discovery key request, the RSC is at least used to be transmitted to a policy control function (PCF) of the UE by the discovery security management function, and the security method assigned to the UE is indicated to the discovery security management function by the PCF based on the RSC.

9. The method according to claim 7, further comprising:
receiving a first relay discovery key response indicating a relay discovery security parameter transmitted by the discovery security management function, wherein the relay discovery security parameter is determined by the discovery security management function in a case where the UE uses the security method assigned to the UE.

10. The method according to claim 7, further comprising:
receiving a second relay discovery key response, wherein the second relay discovery key response is transmitted by the discovery security management function in a case where the UE does not use the security method assigned to the UE.

11. The method according to claim 27, wherein the security method assigned to the UE is determined and indicated to the UE by a policy control function (PCF) of the UE.

12. The method according to claim 7, wherein the discovery security management function comprises one of:
a proximity-based services key management function (PKMF); and
a direct discovery name management function (DDNMF).

13. A method for transmitting information, performed by a policy control function (PCF), comprising:
receiving a relay service code (RSC) of relay discovery transmitted by a discovery security management function, wherein the RSC is used for the PCF to determine a security method assigned to user equipment (UE), the RSC is carried by the UE in a relay discovery key request and transmitted to the discovery security management function, and the relay discovery key request is at least used to request a relay discovery security parameter corresponding to the relay discovery.

14. The method according to claim 13, further comprising:
transmitting indication information indicating a security method assigned to the UE to the discovery security management function, wherein the indication information is used for the discovery security management function to determine whether the UE uses the security method assigned to the UE.

15. The method according to claim 13, wherein the security method assigned to the UE is determined and indicated to the UE by the PCF of the UE.

16-18. (canceled)

19. A communication device, comprising:
one or more processors; and
a memory that stores processor-executable instructions, wherein
the one or more processors are collectively configured to implement the method for transmitting information according to claim 1 when running the executable instructions.

20. A non-transitory computer-readable storage medium, storing a computer-executable program, wherein the computer-executable program, when performed by one or more processors, implements the method for transmitting information according to claim 1.

21. (canceled)

22. A communication device, comprising:
one or more processors; and
a memory that stores processor-executable instructions, wherein
the one or more processors are collectively configured to implement the method for transmitting information according to claim 7 when running the executable instructions.

23. A communication device, comprising:
one or more processors; and
a memory that stores processor-executable instructions, wherein
the one or more processors are collectively configured to implement the method for transmitting information according to claim 13 when running the executable instructions.

24. A non-transitory computer-readable storage medium, storing a computer-executable program, wherein the computer-executable program, when performed by one or more processors, implements the method for transmitting information according to claim 7.
